(19) United States
(12) Patent Application Publication
(10) Pub. No.: US 2019/0204062 A1
(43) Pub. Date: Jul. 4, 2019

(54) METHOD FOR MEASURING A LUBRICATING GAP BETWEEN LUBRICATED CONTACT ELEMENTS

(71) Applicant: ZF FRIEDRICHSHAFEN AG, Friedrichshafen (DE)

(72) Inventor: Georg Tenckhoff, Friedrichshafen (DE)

(21) Appl. No.: 16/324,592

(22) PCT Filed: Jul. 13, 2017
(86) PCT No.: PCT/EP2017/067663

§ 371 Date: Feb. 12, 2019

(30) Foreign Application Priority Data
Aug. 12, 2016 (DE) 10 2016 215 099.5

(51) Int. Cl. G01B 7/14; F16N 29/00

(52) U.S. Cl. CPC G01B 7/14; G01B 17/00; F16N 29/00

(57) ABSTRACT

A method for measuring a lubricating gap between lubricated contact elements includes providing a lubricating gap between the lubricated contact elements, coupling a diagnostic signal into each of the lubricated contact elements, decoupling at least one reflection signal from the lubricated contact elements, and evaluating the diagnostic signal and the reflection signal by an evaluator. The method further includes determining the lubrication state from the evaluated signals.

### CROSS REFERENCE TO RELATED APPLICATIONS

This application is a U.S. National Stage Application under 35 U.S.C. § 371 of International Application No. PCT/EP2017/067663 filed on Jul. 13, 2017, and claims benefit to German Patent Application No. DE 10 2016 215 099.5 filed on Aug. 12, 2016. The International Application was published in German on Feb. 15, 2018 as WO 2018/028920 A1 under PCT Article 21(2).

### FIELD

The invention relates to a method for measuring a lubricating gap between lubricated contact elements.

### BACKGROUND

EP 1 240 455 B1 discloses a method for controlling a lubricant distribution in a lubricating gap. In order to detect the lubricating gap width, sensors are arranged in the region of the lubricating gap. In the region of the lubricating gap, high mechanical loads occur between the contact elements. Sensor elements cannot be reliably attached permanently. There is the risk of damaging the sensor elements due to the mechanical loads.

### SUMMARY

In an embodiment, the present invention provides a method for measuring a lubricating gap between lubricated contact elements. The method includes providing a lubricating gap between the lubricated contact elements, coupling a diagnostic signal into each of the lubricated contact elements, decoupling at least one reflection signal from the lubricated contact elements, and evaluating the diagnostic signal and the reflection signal by an evaluator. The method further includes determining the lubrication state from the evaluated signals.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 provides a schematic representation of a gearbox, with contact elements and lubricating gaps arranged in-between;

FIG. 2 provides a perspective view of contact elements, with the coupling device according to an embodiment of the invention;

FIG. 3 provides a schematic representation of a signal diagram for a method for measuring a lubricating gap by TDR according to an embodiment of the invention;

FIG. 4 provides a representation corresponding to FIG. 2 of a coupling device according to an embodiment of the invention;

FIG. 5 provides a representation corresponding to FIG. 2 of a coupling device according to an embodiment of the invention;

FIG. 6 provides a representation corresponding to FIG. 2 of a coupling device according to an embodiment of the invention; and

FIG. 7 provides a representation corresponding to FIG. 3 of a signal diagram for a method using FDR according to an embodiment of the invention.

### DETAILED DESCRIPTION

Embodiments of the present invention provide methods for measuring a lubricating gap that improve upon prior art methods for measuring a lubricating gap by, e.g., achieving reliable measurement results with reduced effort.

According to the invention, it has been recognized that contact elements, which limit a lubricating gap, can each be interpreted as a line, and in particular, an electrical line. It is thereby possible to use measuring methods which are known from the field of line measurement to measure the lubricating gap. According to the invention, it has been recognized that the contact elements can be measured as lines by means of reflectometry methods, wherein interfaces at which there is mechanical contact with the respective other contact element can be detected as defect points in terms of line measurement. Abrupt changes in the electrical impedance in the contact element are registered at these defect points. Such a method can be made suitable for detecting the lubricating gap between two or more contact elements according to embodiments of the invention. Such a lubricating gap may be present between intermeshing gear wheels in gearboxes and/or as whole body contact.

Methods according to embodiments of the invention enable a reliable measurement of the lubricating gap during operation, i.e., in particular, with rotating gears under load. In particular, it is possible to detect insufficient lubrication if there is direct, metal-to-metal contact between the contact elements. Since it is possible to measure the lubricating gap by means of reflectometry, it is unnecessary to arrange sensor elements in the region of the lubricating gap and/or directly on the lubricating gap. Sensor elements and mechanically less-robust elements of an electronic evaluation unit can be arranged spatially apart from the lubricating gap in a mechanically secure environment. The sensor elements are locally decoupled from the lubricating gap. In reflectometry, a diagnostic signal is respectively coupled into the contact elements. In particular, a diagnostic signal, which is reflected at defect points, is coupled in for each contact element. A reflection signal thus formed is decoupled from the contact elements and evaluated together with the diagnostic signal in an evaluation unit. The lubrication state is determined on the basis of the evaluated signals.

An embodiment of the invention provides a method that enables uncomplicated and immediate evaluation of the signals. In particular, a transmission signal is also considered, i.e., the proportion of the diagnostic signal which is routed, unreflected, through the contact element.

An embodiment of the invention provides a method that enables an immediate conclusion to be drawn regarding the comparison of the signals.

The use of an electrical excitation signal as a diagnostic signal according to an embodiment of the invention enables a particularly advantageous line measurement. In particular, methods for electrical lines such as coaxial cables can be used.

In a method according to an embodiment of the invention, an evaluated reflection signal is interpreted, in particular, directly interpreted, as an impedance change in an interface between contact elements. The interface corresponds to a defect point in the line.

A diagnostic signal according to an embodiment of the invention enables uncomplicated and immediate measurement of the lubricating gap. The underlying method is Time Domain Reflectometry (TDR).

A method according to an embodiment of the invention ensures uncomplicated and immediate evaluation of the state variables.

A method according to an embodiment of the invention enables measurement results with increased significance.

Alternatively, in a method according to an alternative embodiment of the invention, Frequency Domain Reflectometry (FDR) can be used.

In a method according to an embodiment of the invention, the evaluation of the state variables enables improved spatial resolution of defect points.

A method according to an embodiment of the invention ensures uncomplicated and simplified coupling of the diagnostic signals into the contact elements.

A method according to an embodiment of the invention expands the functionality with respect to the measurement evaluation.

A method according to an embodiment of the invention enables measurement results with reduced interference. It is possible to increase signal identification and, in particular, to improve differentiation between signal and noise. The measured signals may be evaluated, in particular, in a defect-free manner.

A method according to an embodiment of the invention enables the lubricating gap to be measured by means of ultrasound.

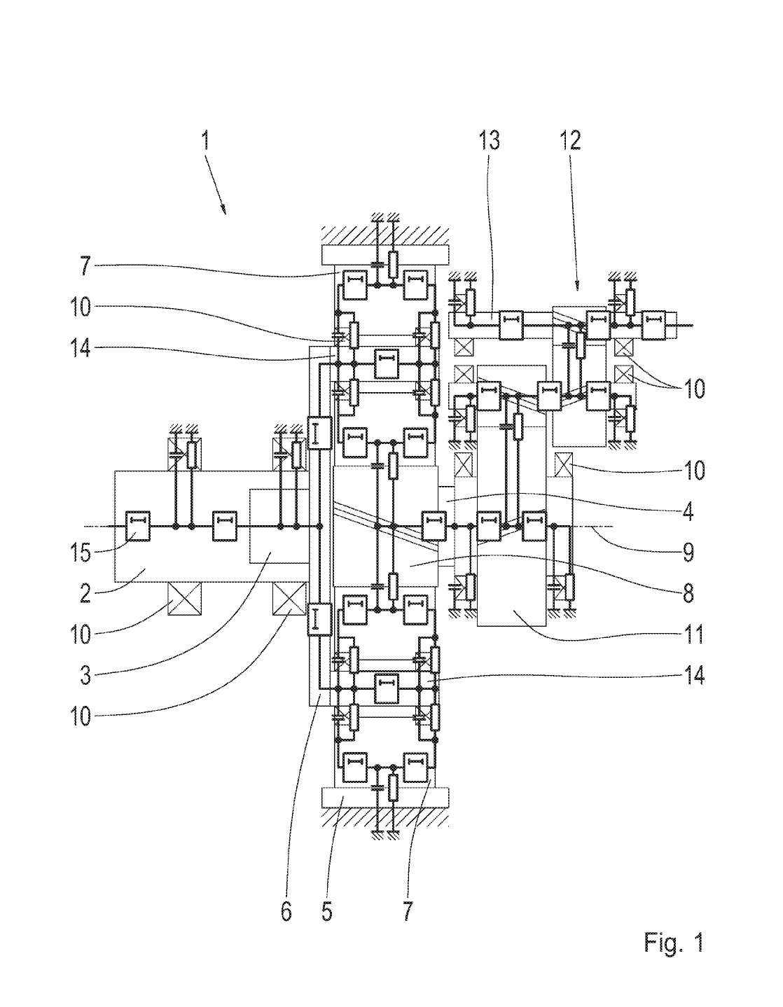

A planetary gear unit 1 shown schematically in FIG. 1 has a hollow shaft ring gear 2, a planetary gear carrier shaft 3, and a sun gear shaft 4. The ring gear hollow shaft 2 is connected to an internally-toothed ring gear 5. The planetary gear carrier shaft 3 is connected to the planetary gear carrier 6. The planetary gear carrier 6 carries several, externally-toothed planetary gears 7, which engage with the inner toothing of the ring gear 5 and with a concentrically-arranged sun gear 8. The sun gear 8 is connected to the sun gear shaft 4. The sun gear 8 is arranged concentrically to a longitudinal axis 9 of the gearbox 1. The planetary gears 7 are arranged eccentrically to the longitudinal axis 9. A rotation of the planetary gear carrier 6 causes a displacement of the planetary gears 7 on a circular path about the longitudinal axis 9.

The ring gear hollow shaft 2 and the planetary gear carrier shaft 3 are arranged concentrically to the longitudinal axis 9. The ring gear hollow shaft 2 surrounds the planetary gear carrier shaft 3 at least partially along the longitudinal axis 9.

The ring gear hollow shaft 2 and the sun gear shaft 4 are each supported via suitable bearings 10 on a gearbox housing, which is not shown.

An output gear 11, which leads to an output shaft 13 via two further gearwheel stages 12, is arranged on the sun gear shaft 4.

The output shaft 13 and the shaft supporting the gear stage 12 are likewise supported by bearings 10 in the gearbox housing. The planetary gears 7 are rotatably supported on pivot pins 14 of the planetary gear carrier 6 by means of bearings 10.

The mechanical components of the planetary gear unit 1 are made of metal. The metallic components can be interpreted as electrical conductors and subjected to diagnostic signals. A diagnostic signal is, for example, an electrical signal. The electric current flowing through the mechanical elements of the planetary gear unit 1 is shown in FIG. 1, represented by a circuit symbol 15. A capacitor 16 and a resistor 17 are both provided in the region of a contact pair, i.e., for example, in the region of the contact between the ring gear hollow shaft 2 and the bearing 10. The circuit diagram of the capacitor 16 and the circuit diagram of the electrical resistor 17 symbolize capacitive or ohmic components of a possible gap impedance, which will be further explained below.

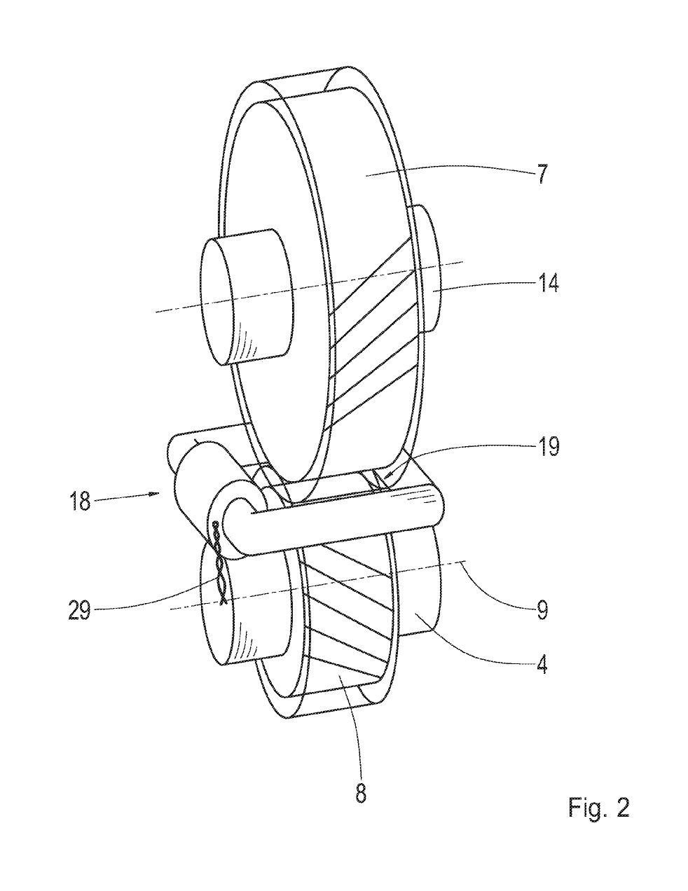

FIG. 2 is used in the following to explain how the diagnostic signal is coupled in, in the region of a contact pair, by means of a coupling device 18. In the exemplary embodiment shown, the contact pair is between the sun gear 8 arranged below, which is fastened to the sun gear shaft 4 and is rotatable about the longitudinal axis 9. The sun gear 8 is externally toothed and engages one of the planetary gears 7, which is held on the pivot pin 14 of the planetary gear carrier (not shown). A lubricating gap 19, which is supplied with lubricant, is formed in the contact area between the planetary gear 7 and the sun gear 8.

The coupling device 18 is designed as a toroidal transformer, wherein the annular surface of the toroidal transformer is arranged in the lubricating gap plane. In addition to the representation shown in FIG. 2 of the coupling device 18 with a coupling element designed as a toroidal transformer, multiple coupling elements can also be provided as an alternative. The lubricating gap plane is arranged, in particular, perpendicular to a plane defined by the rotational axes of the planetary gear 7 and the sun gear 8. The common toroidal transformer for the contact elements 7, 8 is arranged in a region between the contact elements 7, 8.

The coupling device 18 is especially designed to be straightforward and uncomplicated. The coupling device 18 makes it possible to couple one and the same diagnostic signal into both contact elements 7, 8. In particular, it is possible, with only one coupling element, to expose multiple contact elements to the diagnostic signal. The coupling device 18 is designed with electrical lines 29 for coupling in the electrical diagnostic signal 21.

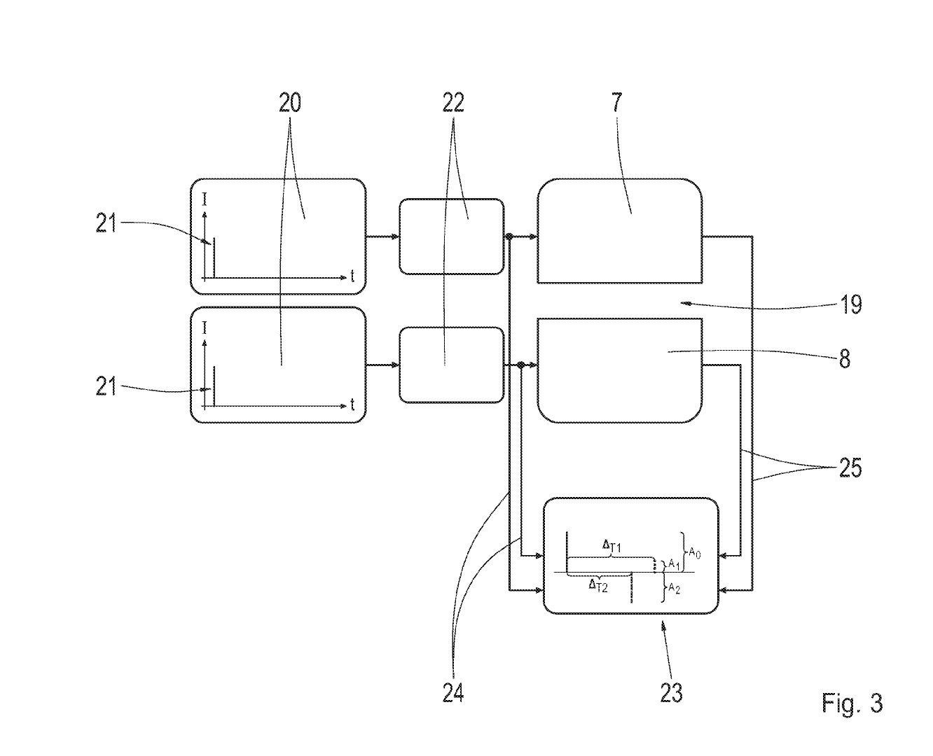

An embodiment of the method for measuring the lubricating gap 19 is explained in more detail in the following by means of FIG. 3. FIG. 3 schematically shows the contact pair comprising the planetary gear 7 and sun gear 8. The two contact elements 7 are each supplied with a diagnostic signal 21, in the form of a current pulse, by a pulse generator 20. The diagnostic signal 21 used, in the form of the pulse signal, serves to apply the TDR. It is advantageous if the pulse signals for the planetary gear 7 and the sun gear 8 each differ from one another. However, it is also possible for identical pulse signals to be coupled in as diagnostic signals.

The diagnostic signals 21 are each guided via an impedance matching device 22 and coupled into the planetary gear 7 and the sun gear 8 by means of the coupling device 18, which is not shown. Ideally, in the region of the lubricating gap 19, no metallic contact is present between the contact elements 7, 8. In this case, the diagnostic signals would be passed through the contact elements 7, 8—ideally, unreflected. The conducted diagnostic signals are transmission signals 25 and are supplied to an evaluation unit 23. Reflection signals 24 are likewise supplied to the evaluation unit 23. The reflection signals 24 originate from defect points in the form of interface contacts between the contact elements 7, 8. The coupled-in diagnostic signal 21 is partially reflected at these interface contacts. The reflection signal 24 is processed as a delayed echo pulse in the evaluation unit. In particular, propagation times and amplitudes of the diagnostic signals and/or of the reflection signals 24 are evaluated in comparison with the transmission signals 25. The evaluation of signals 21, 24, and 25 is based upon the measurement variables of the delay times, the amplitude changes, and the polarity changes of the amplitudes. An impedance change at the interfaces, i.e., the lubricating gaps of the planetary gear 1—in particular, of the participating contact elements 7, 8—can be calculated therefrom. In addition, multiple reflections or their decay can be taken into account in order to draw conclusions about the ohmic component, which is represented by the resistor switching signal 17.

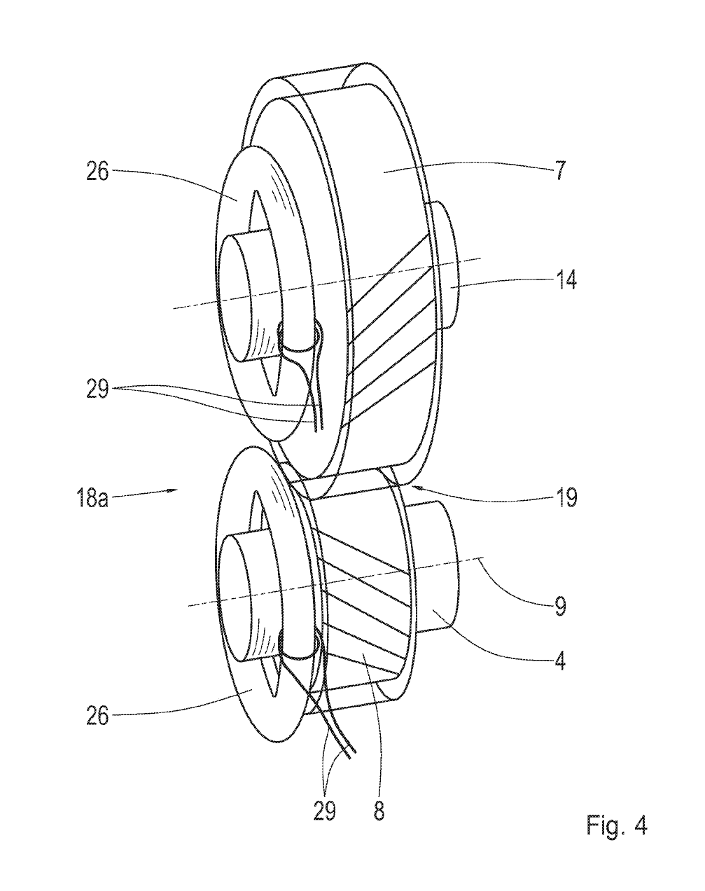

Hereinafter, a further embodiment of the coupling device will be described with reference to FIG. 4. Structurally identical parts are given the same reference numerals as in the first embodiment, the description of which is hereby referenced. Structurally different, but functionally identical parts receive the same reference numerals, with a letter “a” appended.

The coupling device 18a in FIG. 4 has two toroidal transformers 26, each of which is assigned to one of the contact elements 7, 8. The toroidal transformers 26 are of circular design and arranged concentrically to the respective rotational axis of the contact element. The toroidal transformers 26 are respectively arranged on the shafts of the contact elements 7, 8.

The variability during the coupling-in is an advantage with the embodiment of the coupling device 18a with two separate toroidal transformers 26. In particular, it is possible for diagnostic signals 21 deviating from one another to be coupled into contact elements 7 and 8.

The toroidal transformers 26 are each designed in the form of a torus.

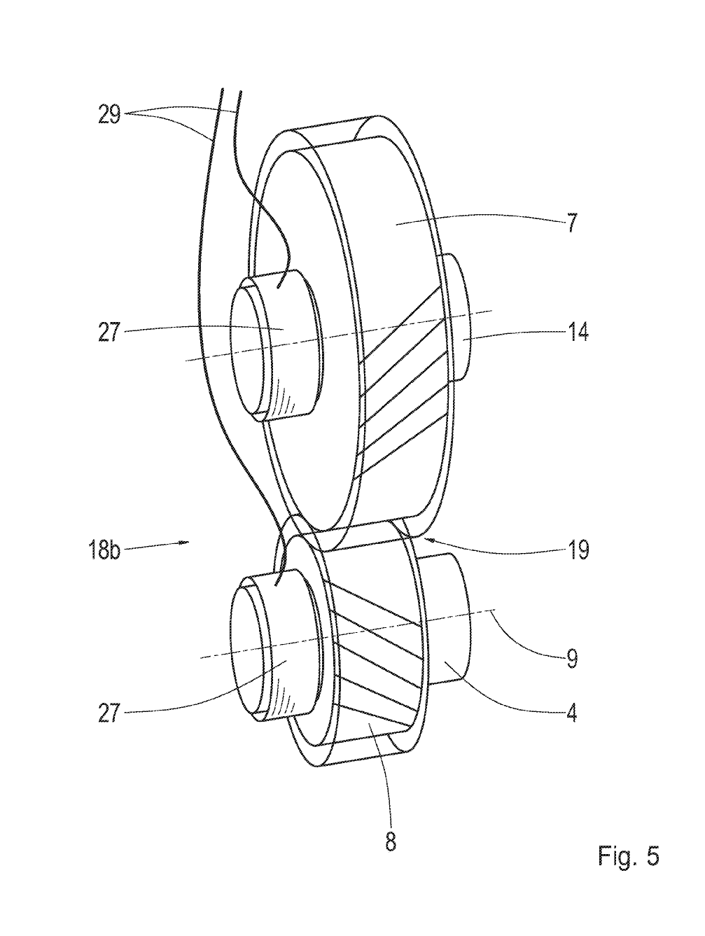

A further embodiment of the present invention is described in the following, with reference to FIG. 5. Structurally identical parts are given the same reference numerals as in the first two embodiments, the description of which is hereby referenced. Structurally different, but functionally identical parts have the same reference numerals, with a letter “b” appended.

With coupling device 18b, two separate toroidal capacitors 27 are also provided, which are each, in the form of a circulating band, folded over on the sun gear shaft 4 or the pivot pin 14. A particularly compact and robust arrangement of the toroidal capacitor 27 on the contact element is thereby possible. The coupling is thereby improved.

A further difference from the previous embodiments is that the coupling device 18b has two toroidal capacitors 27.

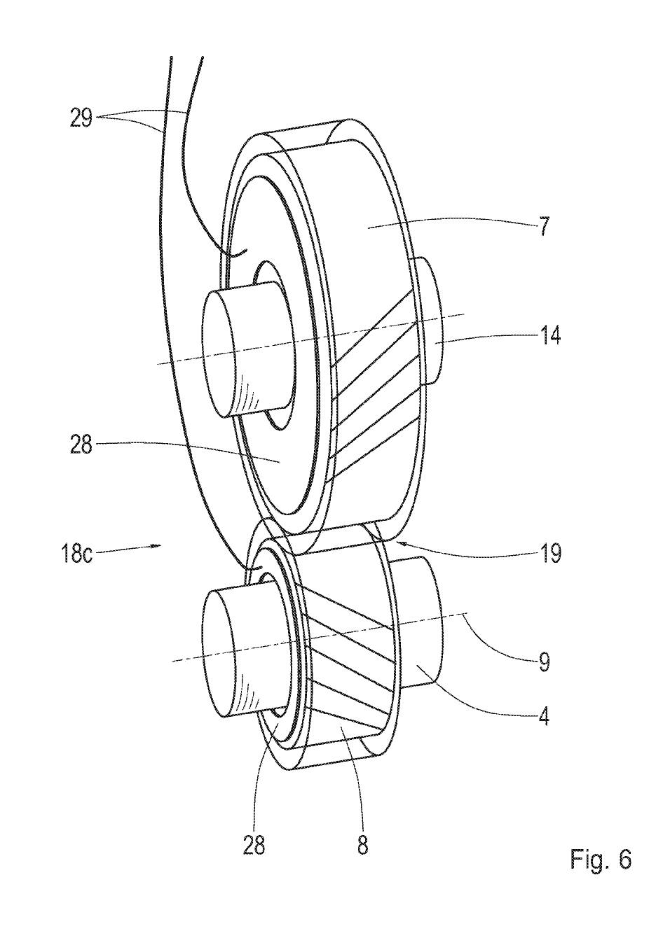

A further embodiment of the present invention is described in the following, with reference to FIG. 6. Structurally identical parts are given the same reference numerals as in the previous embodiments, to the description of which reference is hereby made. Structurally different, but functionally identical parts have the same reference numerals, with a letter “c” appended.

With coupling device 18c, two plate capacitors 28 are provided, each of which is designed to be annular-shaped and is arranged on the end face of the gear wheels 7, 8. Direct coupling of the diagnostic signal 21 into the contact elements is thereby possible. The coupling conditions are thereby improved.

The essential difference from the previous exemplary embodiment is that the capacitors are designed as plate capacitors 28, which are arranged on the end face of the contact elements 7, 8.

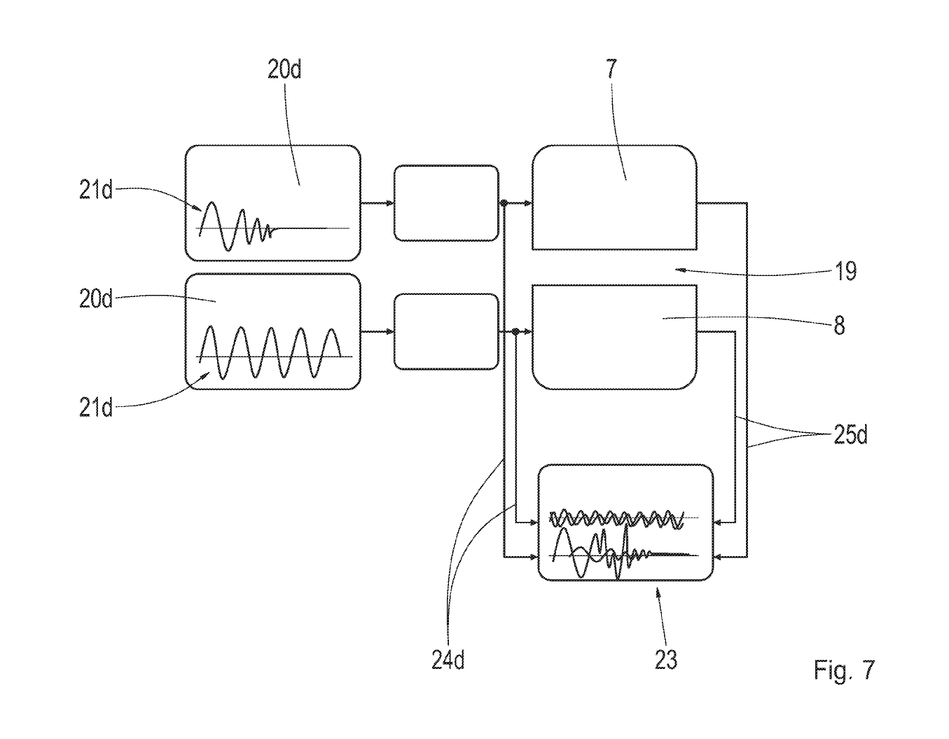

A further embodiment of the method for measuring the lubricating gap 19 is explained in more detail in the following, with reference to FIG. 7. The method is FDR, in which diagnostic signal 21d is a frequency signal, and reflection signal 24d is an interference signal. Conclusions can be drawn about the location, type—for example, resistive or capacitive—and form of the contact gap from the evaluation of the interference signal, as well as from the evaluation of echo pulse 24d.

Accordingly, pulse generators 20d are generators for generating a frequency signal. The generated frequency signal is a diagnostic signal 21d.

In another embodiment (not shown in the figures) of a method, an acoustic signal in the form of ultrasound can be used as the diagnostic signal. In particular, electrical and electromagnetic pulses or frequency signals can be supplemented by the acoustic signals. It is thus conceivable to use diagnostic signals in electrical and/or acoustic form. It is possible to use magnetostrictive or electrostrictive materials—in particular, actuators—which, in particular, do not have to be arranged in the region of the friction/lubricating contact, i.e., in the region of the lubricating gap 19, in order to be able to evaluate acoustic and electrical diagnostic signals in combination. There result different possibilities for coupling-in and decoupling the signals—in particular, an electrical coupling-in and an acoustic decoupling. Due to the reduced propagation speed of sound waves in the affected materials, viz., metal—in particular, steel, oil, and/or air—compared to electromagnetic waves, it is possible to resolve the resolution of both interfaces in the lubricating gap 19, i.e., steel-oil-steel.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Planetary gear unit
2 Ring gear hollow shaft
3 Planetary gear carrier shaft
4 Sun gear shaft
5 Ring gear
6 Planetary gear carrier
7 Planetary gear
8 Sun gear
9 Longitudinal axis
10 Bearing
11 Output gear
12 Gear stage
13 Output shaft
14 Pivot pin
15 Circuit symbol
16 Capacitor
17 Resistor
18, 18a, 18b, 18c Coupling device
19 Lubricating gap
20, 20d Pulse generator
21, 21d Diagnostic signal
22 Impedance matching device
23 Evaluation unit
24, 24d Reflection signal
25, 25d Transmission signal
26 Toroidal transformer
27 Toroidal capacitor
28 Plate capacitor
29 Electrical line

1. A method for measuring a lubricating gap between lubricated contact elements, the method comprising:
providing a lubricating gap between the lubricated contact elements;
coupling a diagnostic signal into each of the lubricated contact elements;
decoupling at least one reflection signal from the lubricated contact elements;
evaluating the diagnostic signal and the reflection signal by an evaluator, wherein an impedance change at the interfaces of the lubricated contact elements is calculated on a basis of delay times, amplitude changes, and/or polarity changes of the amplitudes of the diagnostic signal and/or the reflection signal; and
determining the lubrication state from the evaluated signals.

2. The method according to claim 1, wherein evaluating the diagnostic signal and the reflection signal comprises measuring state variables of the diagnostic signal, of the reflection signal, and/or of a transmission signal.

3. The method according to claim 2, wherein evaluating the diagnostic signal and the reflection signal comprises comparing state variables of the diagnostic signal, of the reflection signal, and/or of the transmission signals.

4. (canceled)

5. The method according to claim 1, further comprising interpreting the evaluated reflection signal as an impedance change at interfaces of the lubricated contact elements.

6. The method according to claim 1, wherein the diagnostic signal is a pulse signal, and wherein the reflection signal is a delayed echo pulse signal.

7. The method according to claim 6, wherein propagation time and/or amplitude are used as state variables for evaluating the diagnostic signal and the reflection signal, and wherein a comparison of the state variables includes determining delay times, amplitude changes, and/or polarity changes.

8. The method according to claim 6, wherein a determination of an ohmic component of gap impedance is effected by evaluating multiple reflections.

9. The method according to claim 4, wherein the diagnostic signal is a harmonic or complex—frequency signal, and wherein the reflection signal is an interference signal.

10. The method according to claim 9, wherein, evaluating the diagnostic signal and the reflection signal comprises determining an interference pattern of the diagnostic signal, the reflection signal, and/or a transmission signal.

11. The method according to claim 1, wherein the coupling is effected contactlessly through capacitive, inductive, or electromagnetic signal transmission.

12. The method according to claim 1, wherein a coupling reflection signal is used as a trigger signal for the reflection signals from the lubricated contact elements.

13. The method according to claim 1, further comprising performing a correlation analysis via a Phase-Locked Loop (PLL) method.

14. (canceled)

15. A coupling device for measuring a lubricating gap between lubricated contact elements, the coupling device comprising:
at least one coupling element;
a pulse generator;
an impedance matching device; and
an evaluator,
wherein, by way of the coupling element, an electrical signal for measuring a lubricating gap can be coupled between lubricated contact elements, and
wherein the coupling device is configured to execute a method according to claim 1.
